(19) United States
(12) Patent Application Publication
(10) Pub. No.: US 2025/0283333 A1
(43) Pub. Date: Sep. 11, 2025

(54) Building Construction Elements and Methods for Manufacturing Building Construction Elements

(71) Applicant: SMARTpanels ApS, Aalborg (DK)

(72) Inventor: Jens MØLLER, Zilina (SK)

(21) Appl. No.: 19/220,385

(22) Filed: May 28, 2025

Related U.S. Application Data
(63) Continuation of application No. PCT/DK2023/050288, filed on Nov. 29, 2023.

(30) Foreign Application Priority Data
Nov. 30, 2022 (DK) PA 2022 01089

(51) Int. Cl. E04C 2/288; B32B 5/18; B32B 7/08; B32B 15/04; B32B 21/04; B32B 27/40

(52) U.S. Cl. CPC E04C 2/2885; B32B 5/18; B32B 7/08; B32B 27/40; B32B 15/046; B32B 21/047; B32B 2266/0278; B32B 2307/102; B32B 2607/00

(57) ABSTRACT

Methods for manufacturing building construction elements, such as walls or horizontal divisions, are disclosed. An exemplary method comprises: a) molding a first layer by arranging in a first mold two parallel spaced apart plates, wherein a plurality of reinforcement elements extend between and connect the spaced apart plates; b) injecting foam polymer into the space between the plates; c) after a cooling process, either placing in the first mold a second layer comprising a plate member and a plurality of reinforcement structures or placing the first layer in a second mold and arranging a second layer comprising a plate member and a plurality of reinforcement structures into the second mold such that the reinforcement structures of the second layer bear against a plate of the first layer; d) injecting foam polymer into the space between the plate member of the second layer and the adjacent plate of the first layer.

### CROSS-REFERENCE TO RELATED APPLICATIONS

This application is a continuation under 35 U.S.C. 111 of International Patent Application No. PCT/DK2023/050288, filed Nov. 29, 2023, which claims the benefit of and priority to Danish Application No. PA 2022 01089, filed Nov. 30, 2022, each of which is hereby incorporated by reference in its entirety.

### FIELD OF INVENTION

The present invention relates to methods for manufacturing a building construction element. The present invention also relates to building construction elements.

### BACKGROUND

In the field of building construction, it is known to manufacture construction elements such as walls and horizontal divisions formed as sandwich structures comprising polyurethane (PUR) or polyisocyanurate (PIR).

When these sandwich structures are produced by using a large block of foam, the block is cut into pieces of desired thicknesses. The pieces are arranged between outer plates. One, however, often experiences the presence of air pockets. Air pockets are created in the construction when the pieces are glued together.

Moreover, when thick pieces are produced in a mold, there can be defects in the molded parts, such as sink marks. A sink mark is a defect on the surface of injection molded parts with variations in wall thickness. Molded portions are typically slightly deformed during the cooling process. Therefore, it would be an advantage to be able to provide an alternative solution.

US 2007048502 A1 discloses a structural sandwich plate member that is provided with a plurality of lightweight hollow spheres within the space between the outer plates. The spheres have a diameter equal to the thickness of the core and are closely packed in a single layer.

AT 298011 B discloses a cladding panel, consisting of at least two solid outer shells made of asbestos cement, chipboard, sheet metal or the like and at least one intermediate layer made of insulating material. The insulating material is preferably mineral wool. The outer shells are firmly connected to one another through the intermediate layer by column-shaped, grid-shaped or strip-shaped connecting elements, preferably made of plastic. These solutions are, however, neither suitable for being manufactured in a fast manner using a mold nor easy to make fireproof.

Thus, there is a need for a method and a building construction element which reduces or even eliminates the above-mentioned disadvantages of the prior art.

### BRIEF DESCRIPTION

A method according to the present disclosure is a method for manufacturing a building construction element, wherein the construction element is a wall or a horizontal division, and the method comprises the following steps:
a) molding a first layer by arranging in a first mold two parallel spaced apart plates, wherein a plurality of reinforcement elements extend between and connect the spaced apart plates, wherein in each end of the plates an end member extends between the plates;
b) injecting PUR or PIR into the space between the plates;
c) after a cooling process, either:
   placing in the first mold a second layer comprising a plate member and a plurality of reinforcement structures that are attached to the plate member and extend perpendicular to the plate member into the first mold in such a manner that the reinforcement structures of the second layer bear against a plate of the first layer; or
   placing the first layer in a second mold and arranging a second layer comprising a plate member and a plurality of reinforcement structures that are attached to the plate member and extend perpendicular to the plate into the mold in such a manner that the reinforcement structures of the second layer bear against a plate of the first layer; and
d) injecting PUR or PIR into the space between the plate member of the second layer and the adjacent plate of the first layer.

Hereby, it is possible to reduce the presence of air pockets. Accordingly, it is possible to provide building construction elements of higher quality. Moreover, it is possible to decrease the thickness of the layers and hereby the tolerances of the layers. Moreover, the method is suitable for manufacturing building construction elements in a fast manner using a mold. Besides, the building construction elements can be made fireproof in an easy manner.

In an embodiment, the construction element is a wall.

In an embodiment, the construction element is a horizontal division.

The method comprises the step of molding a first layer by arranging in a mold two parallel spaced apart plates, wherein a plurality of reinforcement elements extends between and connects the spaced apart plates, wherein in each end of the plates an end member extends between the plates.

Hereafter, PUR or PIR is injected into the space between the plates.

In an embodiment, after a cooling process, the first layer is removed and placed in a second mold.

In an embodiment, after a cooling process, the first layer is maintained placed in the first mold, while an additional layer is added.

In an embodiment, a second layer comprising a plate member and a plurality of reinforcement structures that are attached to the plate member and extend perpendicular to the plate member is placed in the first mold in such a manner that the reinforcement structures of the second layer bear against a plate of the first layer.

In an embodiment, a second layer comprising a plate member and a plurality of reinforcement structures that are attached to the plate member and extend perpendicular to the plate member is placed in the second mold in such a manner that the reinforcement structures of the second layer bear against a plate of the first layer.

Alternatively, the first layer is placed in a second mold, while a second layer comprising a plate member and a plurality of reinforcement structures that are attached to the plate member and extend perpendicular to the plate member is arranged in the mold in such a manner that the reinforcement structures of the second layer bear against a plate of the first layer.

Hereafter, PUR or PIR is injected into the space between the plate member of the second layer and the adjacent plate of the first layer.

In an embodiment, the plates are made of plasterboard or cement plate (concrete plate).

In an embodiment, the method comprises the following steps:
a) before injecting PUR or PIR into the space between the plate member of the second layer and the adjacent plate of the first layer arranging a third layer comprising a plate member and a plurality of reinforcement structures that are attached to the plate member and extend perpendicular to the plate into the first mold or the second mold in such a manner that the reinforcement structures of the third layer bear against a plate of the first layer; and
b) injecting PUR or PIR into the space between the plate member of the third layer and the adjacent plate of the first layer at the same time as injecting PUR or PIR into the space between the plate member of the second layer and the adjacent plate of the first layer.

In an embodiment, the reinforcement elements of the first layer are offset relative to the reinforcement structures of the second layer.

In an embodiment, the reinforcement structures of the second layer and the third layer are aligned with each other (extend along the same planes).

In an embodiment, different foam materials are used in the different layers.

In an embodiment, a sound dampening foam material is used in the second layer or in the third layer.

In an embodiment, the first layer comprises recycled material. Recycled material may be glass fiber parts (from wind turbine blades) by way of example.

In an embodiment, the method comprises screwing one or more screw members into the building construction element and hereby connecting the second plate with the first plate.

In an embodiment, the method comprises screwing one or more screw members into the building construction element and hereby connecting the second layer with the first layer.

In an embodiment, the method comprises screwing one or more screw members into the building construction element and hereby connecting one or more the third layer with the first layer.

A building construction element may be made using a method according to the present disclosure. The building construction element may be a wall or a horizontal division, wherein the building construction element comprises:
a first layer comprising two parallel spaced apart plates and a PIR or PUR foam sandwiched between the plates, wherein a plurality of reinforcement elements extends between and connects the spaced apart plates, wherein in each end of the plates an end member extends between the plates; and
a second layer comprising a plate member, wherein a PIR or PUR foam is sandwiched between the plate of the first layer and the plate member of the second layer, wherein a plurality of reinforcement structures extends between and connects the plate of the first layer and the plate member of the second layer, wherein in each end of the plate of the first layer and the plate member of the second layer an end member extends between the plate and the plate member,
   wherein the first layer and the second layer are attached to each other and extend parallel to each other.

Hereby, it is possible to reduce the presence of air pockets. Accordingly, it is possible to provide building construction elements of higher quality. Furthermore, it is possible to decrease the thickness of the layers and hereby the tolerances of the layers.

In an embodiment, the reinforcement elements are made of a composite material.

In an embodiment, the building construction element comprises:
a third layer comprising a plate member, wherein a PIR or PUR foam is sandwiched between the plate of the first layer and the plate member of the third layer, wherein a plurality of reinforcement structures extends between and connects the plate of the first layer and the plate member of the third layer, wherein in each end of the plate and the plate member an end member extends between the plate and the plate member,
   wherein the first layer and the third layer are attached to each other and extend parallel to each other.

In an embodiment, the reinforcement elements of the first layer are offset relative to the reinforcement structures of the second layer.

In an embodiment, the reinforcement structures of the second layer and the third layer are aligned with each other (extend along the same planes).

In an embodiment, at least some of the reinforcement elements are made of wood, composite, metal (e.g., steel), PUR or PIR.

In an embodiment, all reinforcement elements are made of wood, composite, metal (e.g., steel), PUR or PIR.

In an embodiment, at least some of the reinforcement structures are made of wood, composite, metal (e.g., steel), PUR or PIR.

In an embodiment, all reinforcement structures are made of wood, composite, metal (e.g. steel), PUR or PIR.

In an embodiment, the width between adjacent plates of the first layer is in the range of 5-30 cm, 8-20 cm, or 10-15 cm.

In an embodiment, the thickness of the second layer is less than the thickness of the first layer.

In an embodiment, the thickness of the third layer is less than the thickness of the first layer.

In an embodiment, the lengths between adjacent reinforcement elements of the first layer are in the range of 30-60 cm.

In an embodiment, the lengths between adjacent reinforcement elements of the second layer are in the range of 30-60 cm.

In an embodiment, the lengths between adjacent reinforcement elements of the third layer are in the range of 30-60 cm.

In an embodiment, different foam materials are used in the different layers.

In an embodiment, a sound dampening foam material is used in the second layer or in the third layer.

In an embodiment, at least one of the layers comprises recycled material.

In an embodiment, one or more screw members connect the second layer and the first layer.

In an embodiment, one or more screw members connect the third layer and the first layer.

In an embodiment, the screw members extend perpendicular to the plane of the plate of the second layer.

In an embodiment, the screw members extend perpendicular to the plane of the plate of the third layer.

In an embodiment, the screw member extends perpendicular to the plane of the plate of the third layer.

### BRIEF DESCRIPTION OF THE DRAWINGS

The building construction elements and methods will become more fully understood from the detailed description given herein below. The accompanying drawings are given by way of illustration only, and thus, they are not limitative. In the accompanying drawings:

FIG. 1A shows a schematic cross-sectional view of a first layer of a building construction element according to an embodiment;

FIG. 1B shows the first layer shown in FIG. 1A in a configuration in which PUR or PIR has been injected into the inner spaces of the first layer;

FIG. 2A shows the same first layer as the one shown in FIG. 1B arranged above a second layer;

FIG. 2B shows the same first layer as the one shown in FIG. 2A placed on the second layer;

FIG. 2C shows the same first layer as the one shown in FIG. 2B placed on the second layer when PUR or PIR has been injected into the inner spaces of the second layer;

FIG. 3A shows a cross-sectional view of the layers shown in FIG. 2C;

FIG. 3B shows a third layer being placed on the layers shown in FIG. 3A;

FIG. 3C shows the layers shown in FIG. 3B in a configuration in which PUR or PIR has been injected into the inner spaces of the third layer;

FIG. 4A shows a cross-sectional view of a building construction element (a wall) according to an embodiment;

FIG. 4B shows how screws can be inserted into the building construction element shown in FIG. 4A;

FIG. 5A shows a schematic cross-sectional view of a portion of a first layer of a building construction element according to an embodiment;

FIG. 5B shows a schematic cross-sectional view of the first layer shown in FIG. 5A placed in a mold according to an embodiment;

FIG. 5C shows the first layer shown in FIG. 5B in a configuration in which PUR or PIR has been injected into the inner spaces of the first layer;

FIG. 6A shows a schematic cross-sectional view of a portion of a first layer produced by the mold shown in FIG. 5C;

FIG. 6B shows a schematic cross-sectional view of the first layer shown in FIG. 6A sandwiched between a second layer and a third layer and placed in a mold according to an embodiment;

FIG. 6C shows the first layer shown in FIG. 6B in a configuration in which PUR or PIR has been injected into the inner spaces of the second layer and third layer;

FIG. 7A shows a schematic cross-sectional view of a building construction element placed in a mold, wherein the building construction element comprises a first layer that is sandwiched between a second layer and a third layer;

FIG. 7B shows the building construction element shown in FIG. 7A in a configuration in which PUR or PIR has been injected into the inner spaces of the layers;

FIG. 8A shows an assembly comprising several building construction elements according to an embodiment;

FIG. 8B shows a schematic cross-sectional view of a first layer placed in a mold according to an embodiment; and

FIG. 8C shows a schematic cross-sectional view of the first layer shown in FIG. 8B placed next to a second layer.

### DETAILED DESCRIPTION

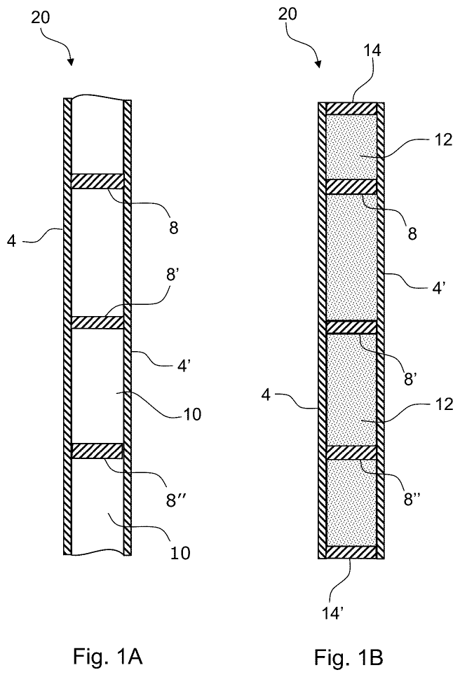

Referring now in detail to the drawings for the purpose of illustrating embodiments of the present building construction elements and methods, FIG. 1A illustrates a schematic cross-sectional view of a first layer 20 of a building construction element according to the present disclosure. The first layer 20 comprises a first plate 4 and a second plate 4′ extending parallel to each other. FIG. 1B illustrates the first layer 20 shown in FIG. 1A in a configuration in which PUR or PIR has been injected into the inner spaces of the first layer.

A plurality of reinforcement elements 8, 8′, 8″ extends between and connects the spaced apart plates 4, 4′. In each end of the plates 4, 4′ an end member 14, 14′ extends between the plates 4, 4′.

In FIG. 1A, the spaces 10 between adjacent reinforcement elements 8, 8′, 8″ and/or end member 14, 14′ are empty. In FIG. 1B, however, PUR or PIR has been injected into the spaces 10. Accordingly, the first layer 20 shown in FIG. 1B comprises two parallel spaced apart plates 4, 4′ and a PIR or PUR foam 12 that is sandwiched between the plates 4, 4′,

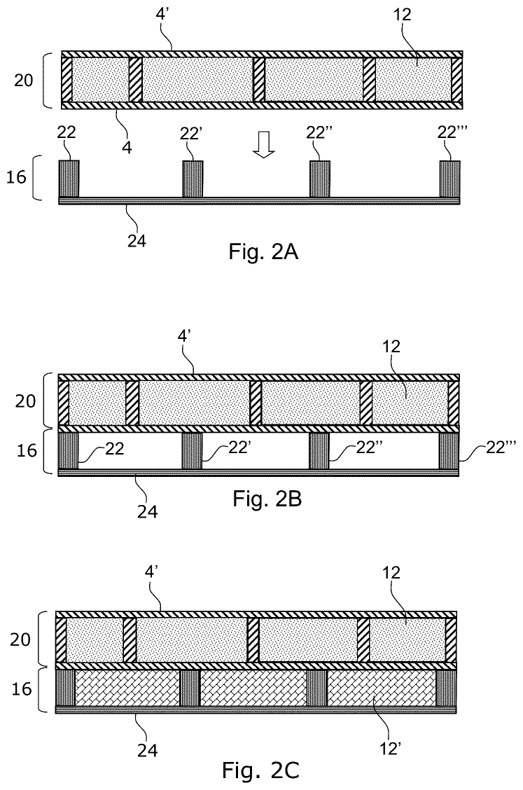

FIG. 2A illustrates first layer 20, such as the one shown in FIG. 1B, arranged above a second layer 16. The second layer 16 comprises a plate member 24 and a plurality of reinforcement structures 22, 22′, 22″, 22′″ extending from the plate member 24. PIR or PUR has been injected into the spaces of the first layer 20.

FIG. 2B illustrates the first layer 20, shown in FIG. 2A, placed on the second layer 16, shown in FIG. 2A.

FIG. 2C illustrates the first layer 20, such as the one shown in FIG. 2B, placed on the second layer 16 when PUR or PIR has been injected into the inner spaces of the second layer 16. Accordingly, the second layer 16 comprises PIR or PUR foam 12′ provided in the spaces of the second layer 16. The second layer 16 is attached to the first layer 20 by the PIR or PUR foam 12′ injected into the spaces of the second layer 16.

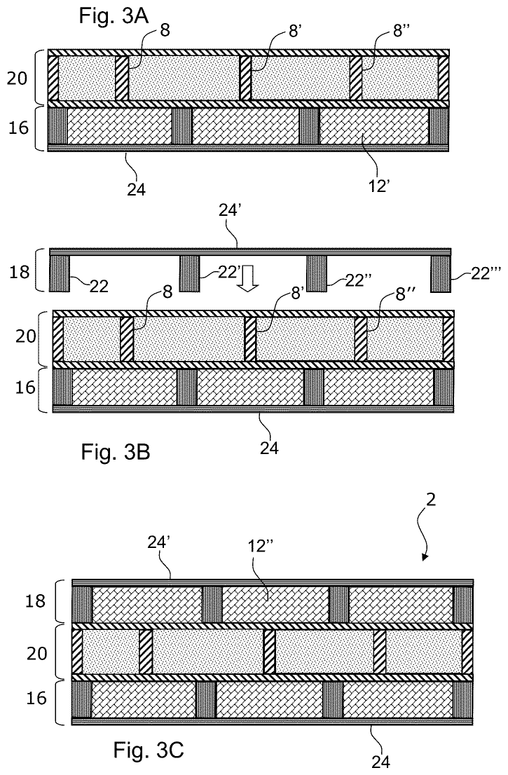

FIG. 3A illustrates a cross-sectional view of the first layer 20 and the second layer 16 shown in and explained with reference to FIG. 2C.

FIG. 3B illustrates a third layer being placed on the layers 20, 16 shown in FIG. 3A. The third layer comprises a plate member 24′. A plurality of reinforcement structures 22, 22′, 22″, 22′″ extends from the plate member 24′.

FIG. 3C illustrates the layers 16, 18, 20 shown in FIG. 3B in a configuration in which PUR or PIR has been injected into the inner spaces of the third layer. The third layer is attached to the first layer 20 by the PIR or PUR 12″ injected into the spaces of the third layer.

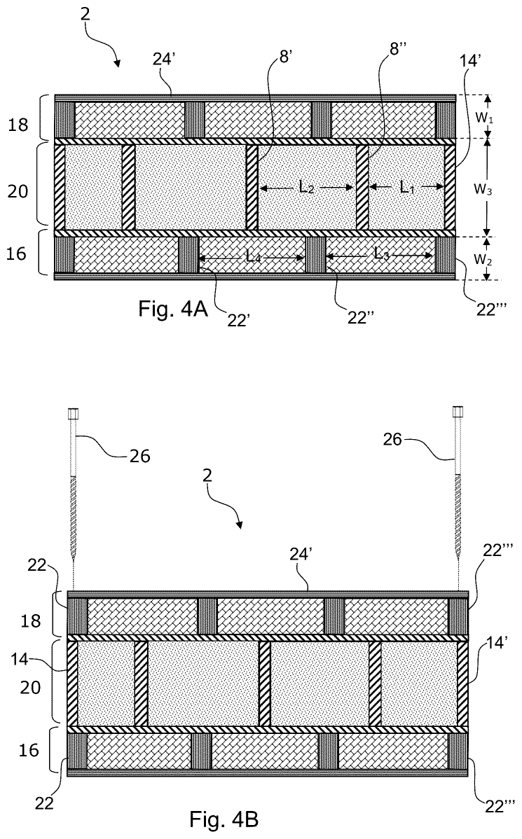

FIG. 4A illustrates a cross-sectional view of a building construction element 2 (a wall) according to the present disclosure. The building construction element 2 basically corresponds to the one shown in FIG. 3C. The width W₃ of the first layer 20 is, however, larger in FIG. 4A than in FIG. 3C.

It can be seen that the width W₁ of the third layer 18 basically corresponds to the width W₂ of the second layer 16. The width W₁ of the third layer 18 and the width W₂ of the second layer 16 is smaller than the W₃ of the first layer 20.

The length L₁ between the reinforcement element 8″ and the end member 14′ is indicated. Likewise, the length L₂ between the two adjacent reinforcement elements 8′, 8″ is indicated. It can be seen that the length L₂ between the two adjacent reinforcement elements 8′, 8″ is larger than the length L₁ between the reinforcement element 8″ and the end member 14′.

The length L₃ between the adjacent reinforcement structures 22″, 22′″ is indicated. Likewise, the length L₄ between the two adjacent reinforcement structures 22′, 22″ is indicated. It can be seen that the length L₃ between the adjacent reinforcement structures 22″, 22′″ corresponds to the length L₄ between the two adjacent reinforcement structures 22′, 22″. The length L₃ between the adjacent reinforcement structures 22″, 22′″ and the length L₄ between the two adjacent reinforcement structures 22′, 22″ does not have to be identical. Accordingly, in an embodiment, the length L₄ between the two adjacent reinforcement structures 22′, 22″ differs from the length L₃ between the adjacent reinforcement structures 22″, 22′″.

FIG. 4B illustrates how screw members 26 can be inserted into the building construction element 2 shown in FIG. 4A. The screw members 26 are screwed into the outermost structures 22, 14, and 22′″, 14′. Hereby, the screw members 26 can secure the layers 16, 18, 20 together.

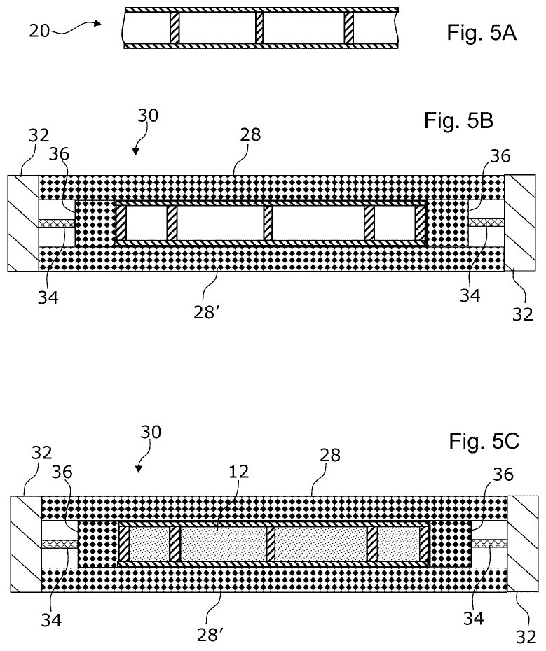

FIG. 5A illustrates a schematic cross-sectional view of a portion of a first layer 20 of a building construction element according to an embodiment.

FIG. 5B illustrates a schematic cross-sectional view of the first layer 20, shown in FIG. 5A, placed in a mold according to an embodiment. The first layer 20 is placed in a mold 30. The first layer 20 comprises empty spaces that need to be filled by injection of PIR or PUR into the spaces.

The mold 30 comprises an upper mold portion 28 extending parallel to a lower mold portion 28′. The mold 30 comprises two spaced apart mold end portions 36 that are moveably arranged so that the distance between the end portions 36 can be changed in order to make the mold fit the length of the first layer.

Each of the end portions 36 is connected to a connection member 34 that is attached to an actuator 32. Each actuator 32 is arranged and configured to displace a connection member 34 and the end portion 36 along the longitudinal axis of the mold 30. Hereby, it is possible to fix the first layer in the mold and hereafter inject PUR or PIR into the spaces of the first layer.

FIG. 5C illustrates the first layer, as shown in FIG. 5B, in a configuration in which PUR or PIR has been injected into the inner spaces of the first layer. Accordingly, PIR or PUR foam 12 is sandwiched between the plates of the first layer.

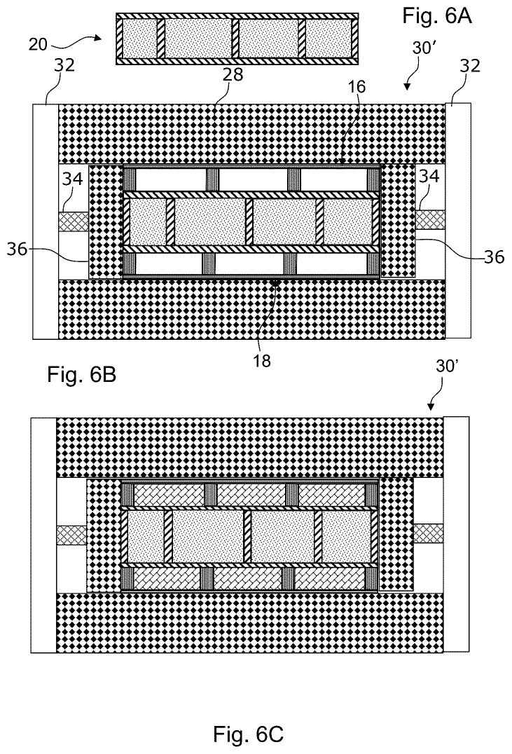

FIG. 6A illustrates a schematic cross-sectional view of a portion of a first layer produced by the mold shown in FIG. 5C.

FIG. 6B illustrates a schematic cross-sectional view of the first layer, shown in FIG. 6A, sandwiched between a second layer and a third layer and placed in a mold 30′ according to an embodiment. The mold comprises basically the same components as the one shown in and explained with reference to FIG. 2B and FIG. 2C. The mold 30′, however, is configured to receive three layers 16, 18, 20.

FIG. 6C illustrates the first layer, shown in FIG. 6B, in a configuration in which PUR or PIR has been injected into the inner spaces of the second layer 16 and third layer 18.

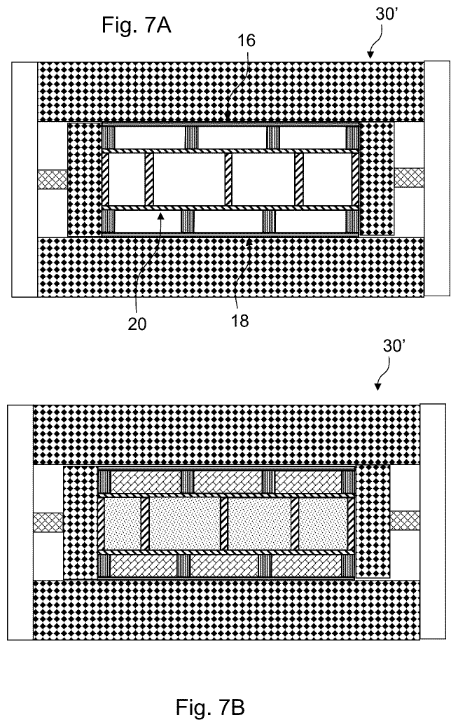

FIG. 7A illustrates a schematic cross-sectional view of a building construction element placed in a mold 30′, wherein the building construction element comprises a first layer that is sandwiched between a second layer and a third layer. All the layers comprise empty spaces.

FIG. 7B illustrates the building construction element shown in FIG. 7A in a configuration in which PUR or PIR has been injected into the inner spaces of the layers. Accordingly, by using the mold 30′ it is possible to inject PUR or PIR into the empty spaces of the layers and at the same time join the adjacent layers.

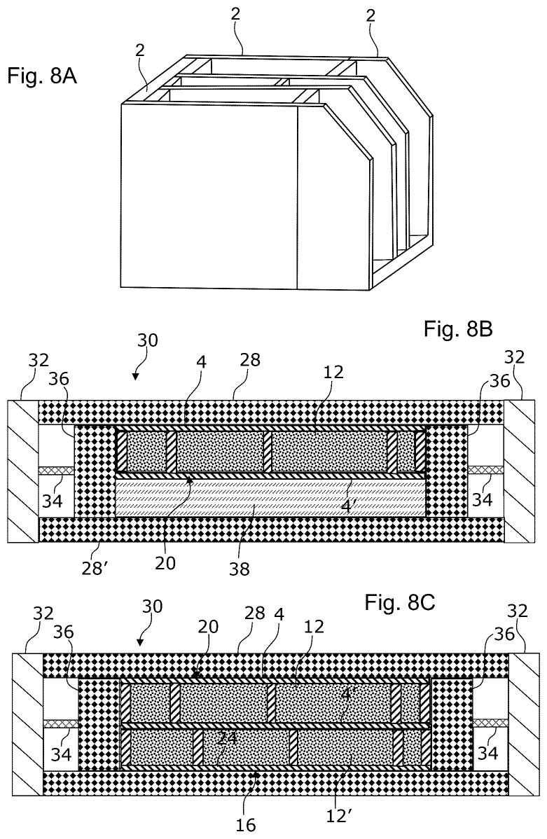

FIG. 8A illustrates an assembly comprising several building construction elements 2 according to an embodiment. The building construction elements 2 constitute a building.

FIG. 8B illustrates a schematic cross-sectional view of a first layer 20 placed in a first mold 30 according to an embodiment. The first layer 20 is placed in a mold 30. The first layer 20 comprises spaces into which PIR or PUR foam 12 has been injected.

The mold 30 comprises an upper mold portion 28 extending parallel to a lower mold portion 28′. The mold 30 comprises two spaced apart mold end portions 36 that are moveably arranged so that the distance between the end portions 36 can be changed in order to make the mold fit the length of the first layer.

Each of the end portions 36 is connected to a connection member 34 that is attached to an actuator 32. Each actuator 32 is arranged and configured to displace a connection member 34 and the end portion 36 along the longitudinal axis of the mold 30. Hereby, it is possible to fix the first layer in the mold and hereafter inject PUR or PIR into the spaces of the first layer. An insert portion 38 is detachably placed adjacent to the first layer 20. Accordingly, the insert portion 38 can be removed as shown in FIG. 8C.

FIG. 8C illustrates a schematic cross-sectional view of the first layer 20, shown in FIG. 8B, placed next to a second layer 16. It can be seen that the insert portion 38 has been removed and a second layer 16 has been placed next to the first layer 20. The second layer 16 comprises PUR or PIR foam 12′ provided between the plate member 24 and the plate 4′ of the first layer 20.

### LIST OF REFERENCE NUMERALS

2 Building construction element
4, 4′ Plate
8, 8′, 8″ Reinforcement element
10 Inner space
12, 12′, 12″ Foam
14, 14′ End member
16 Second layer
18 Third layer
20 First layer
22, 22′, 22, 22′″ Reinforcement structure
24, 24′ Plate member
26 Screw member
28, 28′ Mold portion
30, 30′ Mold
32 Actuator
34 Connection member
36, 36′ Mold end portion
38 Insert portion
W₁, W₂, W₃ Width
L₁, L₂, L₃, L₄ Length

What is claimed is:

1. A method for manufacturing a building construction element, wherein the building construction element is a wall or a horizontal division, the method comprising the following steps:
a) molding a first layer by arranging in a first mold two parallel spaced apart plates, wherein a plurality of reinforcement elements extend between and connect the spaced apart plates, wherein in each end of the plates an end member extends between the plates;
b) injecting PUR or PIR into the space between the plates;
c) after a cooling process, either placing in the first mold a second layer comprising a plate member and a plurality of reinforcement structures that are attached to the plate member and extend perpendicular to the plate member into the first mold such that the reinforcement structures of the second layer bear against a plate of the first layer or placing the first layer in a second mold and arranging a second layer comprising a plate member and a plurality of reinforcement structures that are attached to the plate member and extend perpendicular to the plate member into the mold such that the reinforcement structures of the second layer bear against a plate of the first layer; and
d) injecting PUR or PIR into the space between the plate member of the second layer and the adjacent plate of the first layer.

2. The method according to claim 1, further comprising the following steps:
a) before injecting PUR or PIR into the space between the plate member of the second layer and the adjacent plate of the first layer, arranging a third layer comprising a plate member and a plurality of reinforcement structures that are attached to the plate member and extend perpendicular to the plate member into the first mold or the second mold such that the reinforcement structures of the third layer bear against a plate of the first layer; and
b) injecting PUR or PIR into the space between the plate member of the third layer and the adjacent plate of the first layer at the same time as injecting PUR or PIR into the space between the plate member of the second layer and the adjacent plate of the first layer.

3. The method according to claim 1, wherein the reinforcement elements of the first layer are offset relative to the reinforcement structures of the second layer.

4. The method according to claim 1, wherein the reinforcement structures of the second layer and the third layer are aligned with each other.

5. The method according to claim 1, wherein different foam materials are used in the different layers.

6. The method according to claim 1, wherein a sound dampening foam material is used in the second layer or in the third layer.

7. The method according to claim 1, wherein the first layer comprises recycled material.

8. The method according to claim 1, wherein the method comprises the following steps:
a) screwing one or more screw members into the building construction element and hereby connecting the second layer with the first layer; and/or
b) screwing one or more screw members into the building construction element and hereby connecting the third layer with the first layer.

9. A building construction element made by the method according to claim 1, wherein the building construction element is a wall or a horizontal division, wherein the building construction element comprises:
a first layer comprising two parallel spaced apart plates and a PIR or PUR foam sandwiched between the plates, wherein a plurality of reinforcement elements extends between and connects the spaced apart plates, wherein in each end of the plates an end member extends between the plates; and
a second layer comprising a plate member, wherein a PIR or PUR foam is sandwiched between a plate of the first layer and the plate member of the second layer, wherein a plurality of reinforcement structures extends between and connects the plate of the first layer and the plate member, wherein at each end of the plate and the plate member an end member extends between the plate and the plate member,
wherein the first layer and the second layer are attached to each other and extend parallel to each other.

10. The building construction element according to claim 9, further comprising:
a third layer comprising a plate member, wherein a PIR or PUR foam is sandwiched between the plate of the first layer and the plate member of the third layer, wherein a plurality of reinforcement structures extends between and connects the plate of the first layer and the plate member of the third layer,
wherein at each end of the plate and the plate member an end member extends between the plate and the plate member,
wherein the first layer and the third layer are attached to each other and extend parallel to each other.

11. The building construction element according to claim 10, wherein the reinforcement elements of the first layer are offset relative to the reinforcement structures of the second layer.

12. The building construction element according to claim 10, wherein the reinforcement structures of the second layer and the third layer are aligned with each other.

13. The building construction element according to claim 10, wherein a sound dampening foam material is used in the second layer and/or in the third layer.

14. The building construction element according to claim 10, wherein different foam materials are used in the different layers.

15. The building construction element according to claim 10, wherein:
a) one or more screw members connect the second layer and the first layer; and/or
b) one or more screw members connect the third layer and the first layer.

16. The building construction element according to claim 9, wherein the reinforcement elements of the first layer are offset relative to the reinforcement structures of the second layer.

17. The building construction element according to claim 9, wherein different foam materials are used in the different layers.

18. The building construction element according to claim 17, wherein a sound dampening foam material is used in the second layer.

19. The building construction element according to claim 17, wherein at least one of the layers comprises recycled material.

20. The building construction element according to claim 9, wherein one or more screw members connect the second layer and the first layer.
